(19) United States
(12) Patent Application Publication
(10) Pub. No.: US 2011/0238653 A1
(43) Pub. Date: Sep. 29, 2011

(54) PARSING AND INDEXING DYNAMIC REPORTS

(75) Inventors: Luming Wang, Bellevue, WA (US); Xiaohong Yang, Sammamish, WA (US); Anton Amirov, Redmond, WA (US); Sonal Jain, Bothell, WA (US); Scott Sebelsky, Camano Island, WA (US); Rajeev Karunakaran, Redmond, WA (US)

(73) Assignee: Microsoft Corporation, Redmond, WA (US)

(21) Appl. No.: 12/731,322

(22) Filed: Mar. 25, 2010

(51) Int. Cl. G06F 17/30

(52) U.S. Cl. 707/709; 707/E17.108; 707/711; 707/E17.002; 707/723

(57) ABSTRACT

A parsing and indexing mechanism for dynamically generated reports is provided. Upon detection of a dynamically generated report, a data source for the dynamically generated report may be identified based on metadata or other information associated with the report. Crawleable or machine readable metadata and data may be generated using the data source such that data represented in the report and/or other relevant data from the data source can be indexed and searched.

### BACKGROUND

Search engines discover and store information about documents such as web pages, which they typically retrieve from the textual content of the documents. The documents are sometimes retrieved by a crawler or an automated browser, which may follow links in a document or on a website. Conventional crawlers typically analyze documents as flat text files examining words and their positions (e.g. titles, headings, or special fields). Data about analyzed documents may be stored in an index database for use in later queries. A query may include a single word or a combination of words.

Dynamic reports are documents or portions of the content a document created at runtime. Each time a dynamic report is run, up-to-date data is gathered from a data store and provided to a local computing device executing an application that renders the dynamic report. Typically, the report definition, which remains the same over time, is stored at the local computing device. In contrast, static reports are commonly generated based on retrieved data that is stored along with the report definition (e.g. report parameters) at the local computing device.

Traditional search engines such as the ones discussed above retrieve document contents and index them as plain text. Thus, the data in dynamically generated reports may not be parseable or indexable for a conventional search engine. This may be especially true when the dynamically generated report is non-textual such as a chart, an image, or a video content.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to parsing and indexing of dynamically generated reports. Upon detection of a dynamically generated report, a data source for the dynamically generated report may be identified based on metadata or other information associated with the report. Crawleable or machine readable metadata and data may be generated using the data source such that data represented in the report and/or other relevant data from the data source can be indexed and searched.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating search operations in a networked search environment capable of parsing and indexing dynamically generated reports;

FIG. 2 is a conceptual diagram illustrating search of documents, where some of the documents may include dynamic reports directly connected to an external data source;

FIG. 3 is another conceptual diagram illustrating search of documents, where some of the documents may include dynamic reports connected to an external data source through a middle tier service;

FIG. 4 illustrates an example scenario in a system according to embodiments, where dynamic report parameters may be modified at crawl time;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of parsing and indexing dynamic reports according to embodiments.

### DETAILED DESCRIPTION

As briefly described above, dynamically generated reports may be detected and a data source for the dynamically generated report may be identified based on metadata or other information associated with the report. Machine readable metadata and data may be generated using the data source such that data represented in the report and/or other relevant data from the data source can be indexed and searched. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing computer and network operations, which may include searches. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

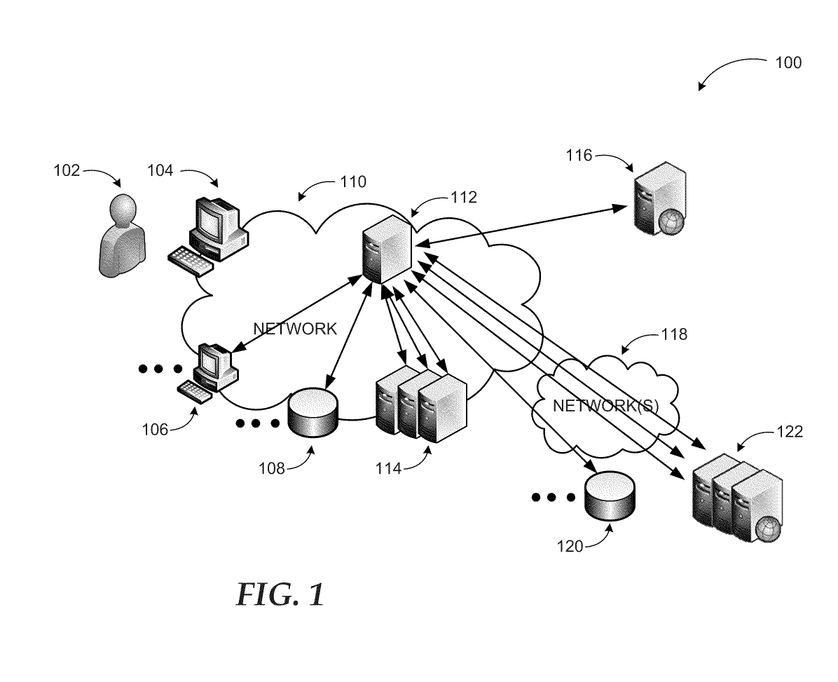

FIG. 1 includes conceptual diagram 100 illustrating search operations in a networked search environment capable of parsing and indexing dynamically generated reports. The networked search environment shown in diagram 100 is for illustration purposes. Embodiments may be implemented in various networked environments such as enterprise-based networks, cloud-based networks, and combinations of those.

Search engines employ a variety of methods to rank the results or index them based on relevance, popularity, or authoritativeness of documents compared to others. Indexing also allows users to find sought information promptly. When a user submits a query to a search engine (e.g. by using key words), the search engine may examine its index and provide a listing of matching results according to predefined criteria. The index may be built from the information retrieved from the contents of the crawled document and/or user data and the method by which the information is indexed. The query may include parameters such as Boolean operators (e.g. AND, OR, NOT, etc.) that allow the user to refine and extend the terms of the search.

As discussed previously, dynamic reports are created at runtime gathering data from a data store. The data store may be on the same computing device as the application rendering the report or on a different computing device connected through a network. The report may present a portion (or whole) of the available data from the data store textually or graphically. The report may even be in video format (e.g. a time dependent report that presents changes in selected data). Thus, the underlying data is typically not available in textual format from the report itself. Indeed, the report may not even include keywords or search terms that are being used to perform a search.

A search engine according to embodiments enables enhanced indexing and searching detecting a report type, determining a data source associated with the detected report, retrieving the underlying data from the data source, and rendering the dynamic report machine-readable, thereby searchable employing keywords or search terms. The information extracted, organized, ranked, and annotated may be indexed and stored for caching and faster retrieval when searched by a user.

In the example system of diagram 100, user 102 may interact with a variety of networked services through their client 104. Client 104 may refer to a computing device executing one or more applications, an application executed on one or more computing devices, or a service executed in a distributed manner and accessed by user 102 through a computing device. In a typical system client 104 may communicate with one or more servers (e.g., server 112). Server 112 may execute search operations for user 102 searching documents on server 112 itself, other clients 106, data stores 108, other servers of network 114, or resources outside network 110.

In an example scenario, network 110 may represent an enterprise network, where user 102 may submit a search request. A search application on server 112 may crawl and evaluate documents detecting dynamic reports and determining associated data sources. The crawled documents and retrieved information may be used to index machine-readable data with additional information from data sources associated with crawled documents. The search may also include resources outside network 110 such as server 116 or servers 122 and data stores 120, which may be accessed through at least one other network 118. The search may be performed on a database source, an analysis service, a portal, another server, and/or a desktop.

The example system in FIG. 1 has been described with specific servers, client devices, software modules, and interactions. Embodiments are not limited to systems according to these example configurations. Parsing and indexing of dynamic reports may be implemented in configurations employing fewer or additional components and performing other tasks. Furthermore, specific protocols and/or interfaces may be implemented in a similar manner using the principles described herein.

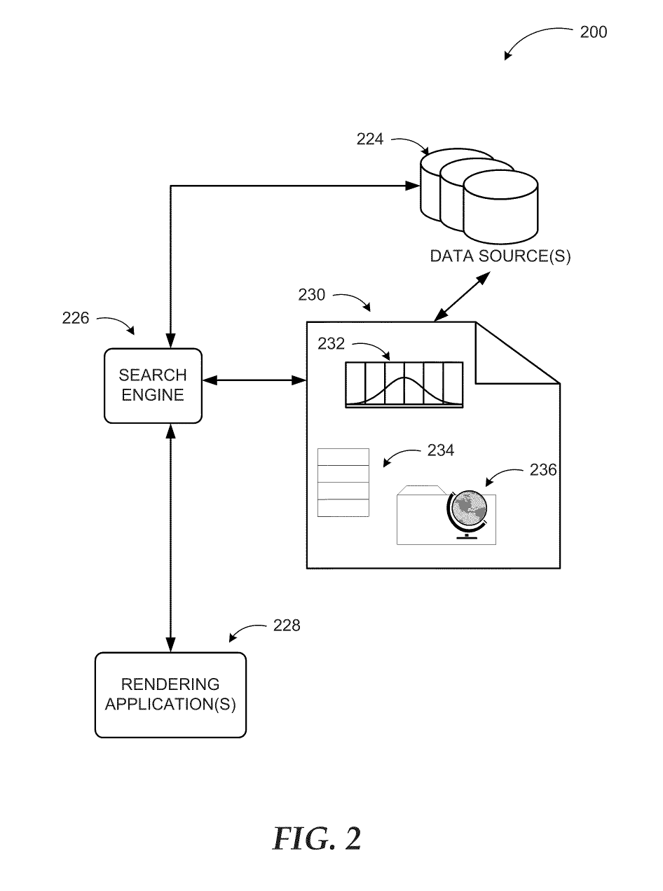

FIG. 2 is a conceptual diagram illustrating search of documents, where some of the documents may include dynamic reports directly connected to an external data source. As discussed above, dynamically generated reports are difficult to crawl. Especially when the report renders as an image or a video content (instead of textual data) that includes little metadata and is not machine readable. Some dynamically generated reports may not even include search terms. Instead of trying to parse and index the generated report itself, a search engine according to embodiments determines the source of the report. Then, based on a type of the report, crawleable metadata and data are generated from the report and its source.

A search engine according to embodiments (e.g. search engine 226) may find documents that include textual data, graphic data, video data, tables, images, and similar forms of embedded content. Some of the embedded content (or the entire document) may be dynamically generated reports, which receive their data from an external data source such as data source 224. Document 230 is an example document that includes table 234 (textual data), graphic chart 232, and video data 236. The presented data may not be physically stored along with the document 230 itself. Thus, a conventional flat text search may not detect the dynamic data represented by any of these elements.

In a system according to embodiments, search engine 226 may first detect a type of the dynamic report(s) based on metadata associated with a portal publishing the document or based on a document identifier (e.g. a Uniform Resource Locator “URL” assigned to the report/document). Next, a two-step crawl process may be executed, where a definition of the document is parsed and associated metadata and/or data directly retrieved from the definition first. The second step of the crawl process may include detecting the dynamic rendering part of the document (report) and based on the report type, calling associated web services, custom code/methods/middle tier services, a local report rendering engine, a database, a data warehouse, and/or other data sources to convert the dynamic portion to a machine-readable format.

Search engine 226 may then index crawl results for faster search responses building an index. The search engine may also rank search results based on the types of reports embedded into the document and the retrieved external data, and enable presentation of the additional information when search results are rendered by rendering application(s) 228 such that users can determine importance/relevance of a document for their search.

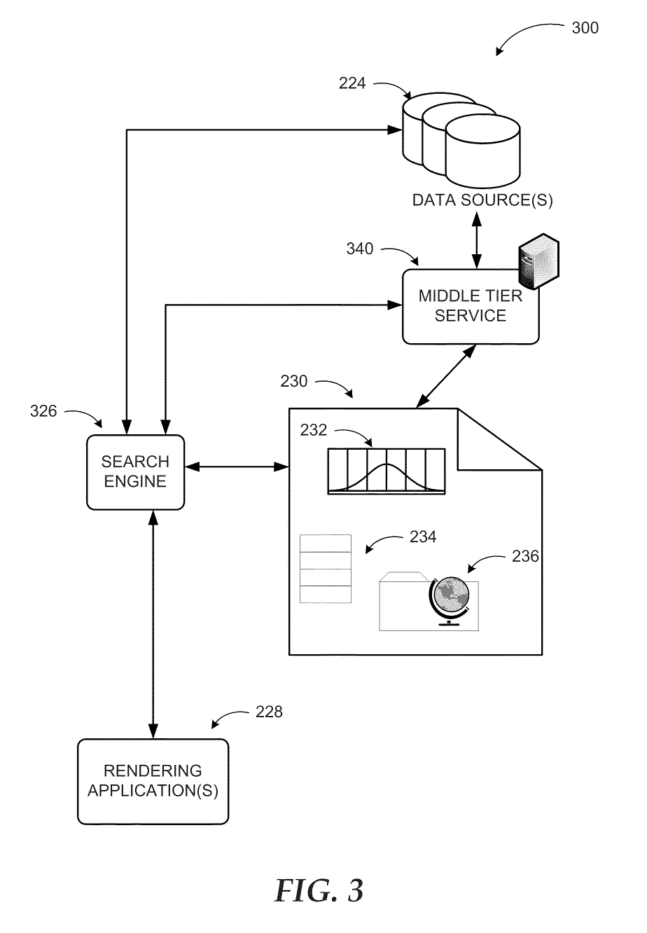

FIG. 3 includes conceptual diagram 300 illustrating search of documents, where some of the documents may include dynamic reports connected to an external data source through a middle tier service. Document 230 and its embedded example reports are the same in diagram 300 as in diagram 200 of FIG. 2. So, are the rendering application(s) 228 and data sources 224.

Differently from FIG. 2, the reports in document 230 of FIG. 3 receive their data from data sources 224 through a middle tier service 340 instead of directly. Thus, metadata associated with document 230 or anyone of its dynamic reports may not specifically identify data sources 224 or any properties associated with the data sources. However, search engine 326 may determine middle tier service 340 from a portal publishing document 230 or a URL of the document and retrieve information associated with the underlying data (e.g. type of data, URL of data sources 224, etc.) from middle tier service 340. Then, the search engine 326 may generate machine-readable data from the dynamic reports as discussed above.

According to some embodiments, document 230 may be a business intelligence document such as spreadsheet document, dashboards, or scorecards that contain tables, charts, reports, diagrams, filtered charts/tables, and similar elements. Some of these elements may be generated by an application other than the spreadsheet application associated with the spreadsheet document and embedded into the spreadsheet document statically or dynamically (i.e. element data residing at an external source). The reports (e.g. charts and/or diagrams) may be generated based on filtering data available from middle tier service 340 or data sources 224. Thus, the reports in document 230 may not reflect the entire extent of available data.

Since external data may be stored in different data sources such as various databases, servers, tables, and comparable ones, the metadata associated with each data and data storage may be different. Search engine 326 may determine data type associated with each detected report within a document, range of data, and data storage type. Then, crawl operations may be customized to retrieve information associated with each report and data for each report.

Moreover, a user interface of rendering application(s) 228 (or the search engine 326) may be adjusted in accordance with the indexing and ranking strategy, such that search results for different kinds of dynamic reports may be displayed in a unified and consistent manner. For example, data may be categorized as being associated with a chart-based report, a table-based report, a video-based report, and comparable ones, and search results may indicate each result's category textually and/or graphically.

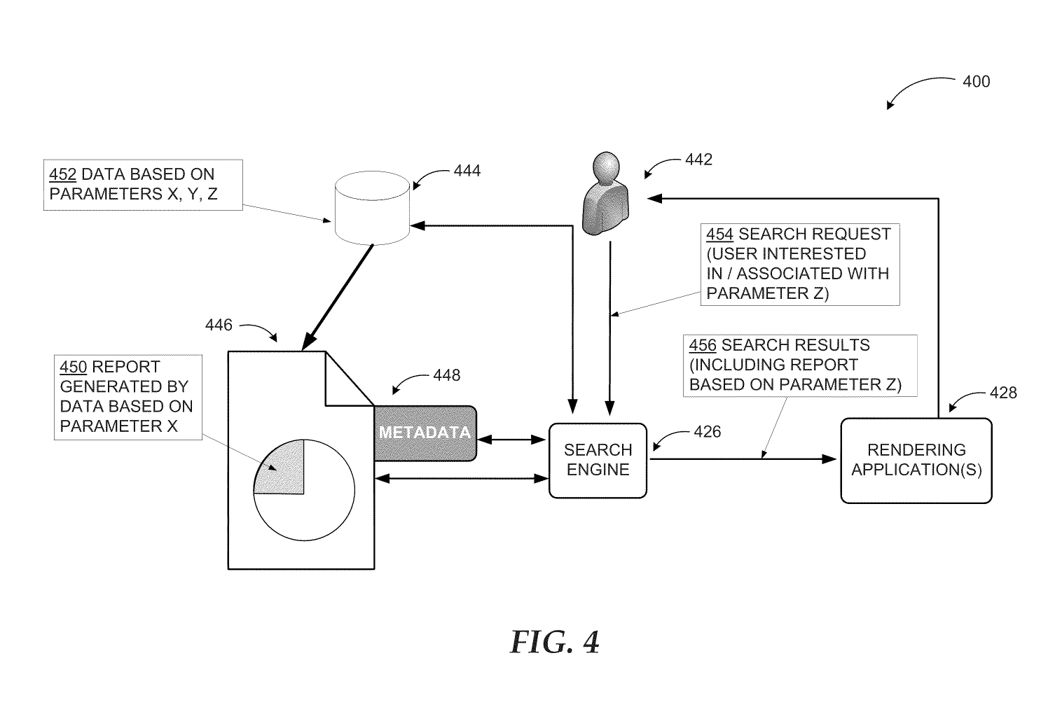

FIG. 4 illustrates an example scenario in a system according to embodiments, where dynamic report parameters may be modified at crawl time. Because the data presented by a dynamic report may be limited (e.g. filtered from the available data at the external data source), a search engine according to embodiments may retrieve additional information from the data source to enrich the search results. For example, additional dimension members beside the applied filter members may be retrieved from the data at the data source, values of filtering parameters may be modified, etc.

According to an example scenario displayed in diagram 400, document 446 may include a dynamically generated report 450 based on data from external data source 444. While the data (452) stored in data source 444 may be based on example parameters X, Y, and Z, the dynamic report 450 may present data based on parameter X only (e.g. data source may store sales data for worldwide activities by country and the report may only display a chart based on North American sales). Search engine 426 crawling documents in preparation for a search request from user 442 may find document 446, detect a type of report embedded in the document based on metadata 448 (e.g. identifier) and gather relevant information from data source 444 such that the presented data (based on parameter X) as well as additional available data (based on parameters Y and Z) are made available for searching. Thus, user 442 may be able to retrieve data based on all three parameters, individually or in combination, from data source 444 following the presentation format of report 450 (or in another format) according to embodiments.

For example, search request 454 from user may indicate user's interest in data based on parameter Z. Following the above described operations, search engine 426 may modify the parameter for the dynamic report, and render data based on parameter Z available from data source 444 in search results 456 to rendering application 428. Following the above described example, user 442 may be interested in sales data for Japan. In a conventional search, report 450 may be disregarded because it only presents North American sales data or listed in the results but skipped as irrelevant by the user. A search engine according to embodiments, not only determines that there is more underlying data associated with report 450, but renders that data searchable and limits its scope to the focus of the user's search. Thus, the results of the search for sales data in Japan may bring back a chart similar to the one displayed in report 450 based on sales data for Japan or access to the data in searchable form (again based on sales in Japan). According to other embodiments, the search engine may render the entire data from data source 444 available.

The examples in FIGS. 2, 3, and 4 have been described with specific document types, reports, data types, and interactions. Embodiments are not limited to systems according to these example configurations. Parsing and indexing of dynamically generated reports may be implemented in configurations using other types of documents, reports, and data in a similar manner using the principles described herein.

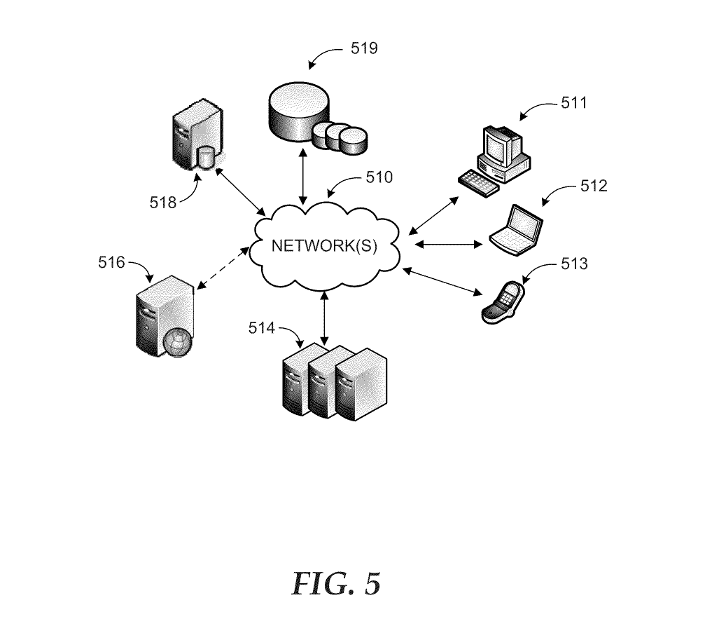

FIG. 5 is an example networked environment, where embodiments may be implemented. A platform providing searches that can determine dynamic reports and render data associated with the dynamic reports machine-readable (and, thereby, searchable) may be implemented via software executed over one or more servers 514 such as a hosted service. The platform may communicate with client applications on individual computing devices such as a smart phone 513, a laptop computer 512, or desktop computer 511 (client devices') through network(s) 510.

Client applications executed on any of the client devices 511-513 may submit a search request to a search engine on the client device 511-513, on the servers 514, or on individual server 516. The search engine may crawl documents with dynamic reports, detect report type(s), call relevant web services or report rendering engines to generate searchable format data based on the report as discussed previously. The service may retrieve relevant data from data store(s) 519 directly or through database server 518, and provide the ranked search results to the user(s) through client devices 511-513. The service may further provide filtering and/or dimensioning of results by modifying filtering parameters associated with the dynamic report(s).

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a framework for parsing and indexing dynamic reports. Furthermore, the networked environments discussed in FIG. 5 are for illustration purposes only. Embodiments are not limited to the example applications, modules, or processes.

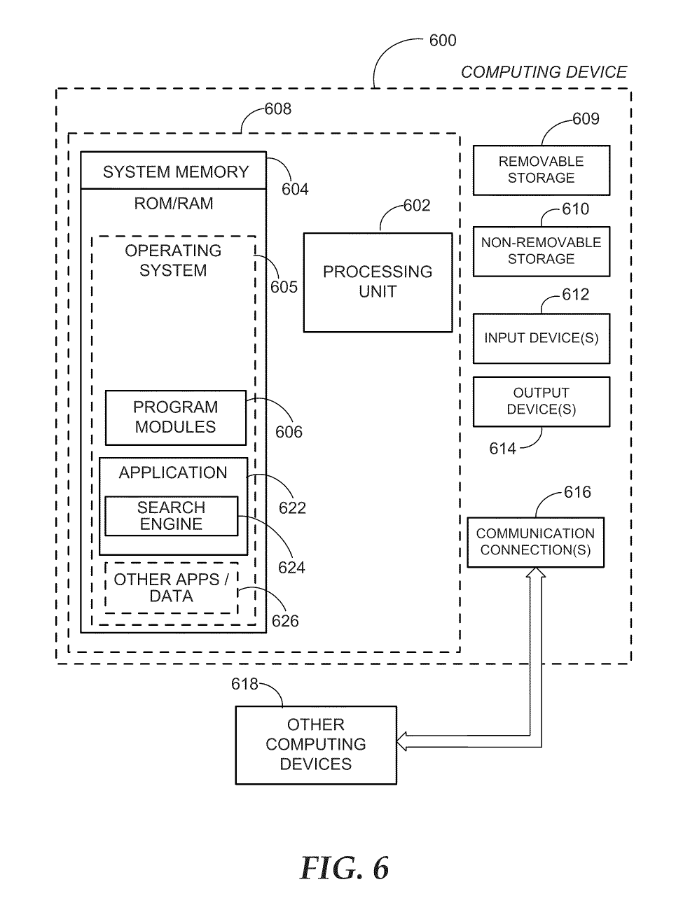

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a client device executing a client application capable of performing searches or a server executing a service capable of performing searches according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, search capable application 622, search engine 624, and optionally other applications/data 626.

Application 622 may be any application that is capable of performing search through search engine 624 on other applications/data 626 in computing device 600 and/or on various kinds of data available in an enterprise-based or cloud-based networked environment. Search engine 624 may crawl, index, perform searches, and rank results detecting dynamic reports, determining data sources, and rendering presented data searchable as discussed previously. Application 622 and search engine 624 may be separate applications or an integral component of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, other web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

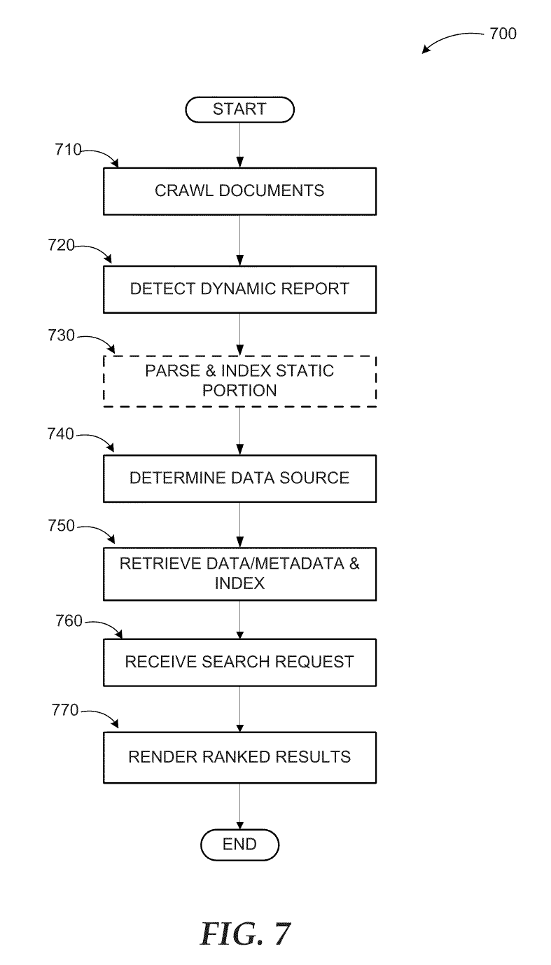

FIG. 7 illustrates a logic flow diagram for process 700 of parsing and indexing dynamic reports according to embodiments. Process 700 may be implemented as part of an application executed on a server or client device.

Process 700 begins with operation 710, where search contents are crawled for indexing purposes. As discussed previously searches may be performed in a desktop environment, an enterprise-based network, a cloud-based network, or a combination of an enterprise-based network and a cloud-based network. At operation 720, dynamic reports may be detected based on information associated with a portal publishing the document containing the report or an identifier of the report/document.

At optional operation 730, static portion(s) of the document may be parsed and data/metadata retrieved for indexing. At operation 740, a data source associated with the report may be determined from metadata. This may be followed by operation 750, where the underlying data is rendered searchable and indexed. In response to receiving a search request at operation 760, search results based on indexed information may be provided to the requesting user at operation 770.

The operations included in process 700 are for illustration purposes. Parsing and indexing of dynamically generated reports may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for parsing and indexing dynamically generated reports, the method comprising:
crawling searched contents;
determining a report type for a detected report, the report dynamically presenting data from an external data source;
determining the data source associated with the detected report based on metadata associated with the report;
rendering data associated with the detected report from the data source searchable employing one of: a web service, a custom code, a custom method, a middle tier service, a local report rendering engine, a database, and a data warehouse; and
indexing crawl results including the searchable data associated with the detected report.

2. The method of claim 1, further comprising:
determining the report type from one of metadata associated with a portal publishing the detected report and an identifier associated with the detected report.

3. The method of claim 2, wherein the identifier associated with the detected report is a Uniform Resource Locator (URL).

4. The method of claim 2, wherein the detected report is embedded into a document that further includes static data stored in the document.

5. The method of claim 4, wherein the identifier is associated with a URL of the document, and the method further comprises:
parsing and indexing the static data stored in the document.

6. The method of claim 1, wherein the detected report includes at least one from the set of: a chart, a diagram, an image, and a video presentation graphically representing a portion of data stored at the external data source.

7. The method of claim 1, wherein rendering data associated with the detected report from the data source searchable includes retrieving textual data from the external data source corresponding to the graphical representation in the detected report.

8. The method of claim 1, wherein the crawl is performed in one of a desktop environment and a networked environment, and the external data source includes one of: a document and a database on one of a server, a client device, and a data store.

9. The method of claim 1, further comprising:
customizing crawl operations based on at least one from the set of: a type of the detected report, a type of the external data source, and a type of the data associated with the detected report.

10. The method of claim 1, further comprising:
in response to a search request performing a search based on data rendered searchable by rendering the report employing filter values matching a search query;
ranking search results based on at least one from the set of a type of the detected report, the external data source, and metadata associated with the report; and
including information associated with the type of the detected report rendered search results.

11. A computing device for parsing and indexing dynamically generated reports in search operations, the computing device comprising:
a memory;
a processor coupled to the memory, the processor executing a search engine in conjunction with instructions stored in the memory, wherein the search engine is configured to:
crawl searched contents;
detect a dynamically generated report embedded within a document, wherein the dynamically generated report includes non-crawleable data and the document further includes crawleable static data;
determine a report type and an external data source associated with the dynamically generated report based on metadata associated with the document;
determine a type of data associated with the dynamically generated report stored in the external data source; and
render the data associated with the dynamically generated report stored in the external data source crawleable.

12. The computing device of claim 11, wherein the dynamically generated report represents a portion of the data stored in the external data source based on a first value of a filtering parameter.

13. The computing device of claim 12, wherein the search engine is further configured to:
determine a range of the filtering parameter; and
render the data stored in the external data source crawleable based on an entire range of the filtering parameter.

14. The computing device of claim 12, wherein the search engine is further configured to:
determine a second value of the filtering parameter based on a search request from a user; and
render the data stored in the external data source crawleable based on the second value of the filtering parameter.

15. The computing device of claim 11, wherein the search engine is further configured to:
enable rendering of search results associated with the detected report based on at least one of: data presented in a format employed by the dynamically generated report and data presented in a textual format.

16. The computing device of claim 11, wherein the search is performed on at least one from a set of: a database source, an analysis service, a portal, another server, and a desktop, and wherein the computing device is coupled to one of: an enterprise-based network, a cloud-based network, and a combination of an enterprise-based network and a cloud-based network.

17. A computer-readable storage medium with instructions stored thereon for parsing and indexing dynamically generated reports in search operations, the instructions comprising:
crawling searched contents;
detecting a dynamically generated report within a document of the searched contents, the report graphically representing data from an external data source based on a filtering parameter;
determining a report type based on one of: metadata associated with a portal publishing the document and an identifier associated with the detected report;
retrieving data and metadata from a static portion of the document by parsing a definition of the document;
determining the external source based on metadata associated with the report; and
retrieving data and metadata from the external data source associated with the dynamically generated report.

18. The computer-readable medium of claim 17, wherein the instructions further comprise:
determining a middle tier service based on the metadata associated with the report; and
determining the external source based on one of data and metadata retrieved from the middle tier service.

19. The computer-readable medium of claim 17, wherein the instructions further comprise:
modifying a value of the filtering parameter based on a search request from a user;
retrieving data and metadata from the external data source based on the modified filtering parameter; and
presenting the retrieved data in one of a format employed by the dynamically generated report and a textual format in search results.

20. The computer-readable medium of claim 17, wherein the type of report is employed to limit a scope of data to be retrieved from the external data source based on a focus of the search request from a user.
